(19) United States
(12) Patent Application Publication
(10) Pub. No.: US 2013/0309900 A1
(43) Pub. Date: Nov. 21, 2013

(54) Multi-Socketed Electrical Conduit Apparatus

(71) Applicants: Kevin Ramsier, DeWitt, MI (US); Jamey Gelina, Charlotte, MI (US)

(72) Inventors: Kevin Ramsier, DeWitt, MI (US); Jamey Gelina, Charlotte, MI (US)

(21) Appl. No.: 13/475,641

(22) Filed: May 18, 2012

(51) Int. Cl. H01R 3/00; H01R 13/60

(52) U.S. Cl. 439/488; 439/535

(57) ABSTRACT

A multi-socketed electrical conduit apparatus for providing power to the outside of a building when there is not an outdoor power socket available. The conduit apparatus includes a prewired conduit that passes through a wall. The conduit is rugged, flexible, and may include numerous elbows and extensions to navigate through studs, wires, and piping. A first socket of the conduit faces outside the building, while a second socket faces inside the building. Both sockets rest flush against both walls, giving the appearance of permanent fixtures. A cable operably joins an indoor power source with the second socket. The subsequent power transmits through the conduit, and becomes available to the first socket. The conduit may also be operable to transfer power wirelessly. In this manner, the outdoor socket may receive power from numerous indoor power sources rather than depending on an extension power cord.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to electrical apparatuses. More particularly, one or more embodiments of the invention relate to electrical extension apparatuses.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often outdoor tools require a typical power source from a standard wall outlet. Typically an outdoor wall outlet is needed to power these tools. In many cases an outdoor wall outlet may be far from the desired location, or there may be no outdoor wall outlets at all.

Installation of an outdoor wall outlet may be prohibitively expensive. Further, many modern electrical codes prohibit cabling or wiring from the outside of an exterior wall to the inside of the exterior wall. Currently there are no devices which allow the power from an indoor wall outlet to be safely and inexpensively extended to an outdoor wall outlet.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary electrical extension apparatus according to an embodiment of the present invention;

FIG. 2 illustrates a front view of an exemplary electrical extension apparatus according to an embodiment of the present invention;

FIG. 3 illustrates a back view of an exemplary electrical extension apparatus according to an embodiment of the present invention; and

FIG. 4 illustrates a bottom view of an exemplary electrical extension apparatus according to an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

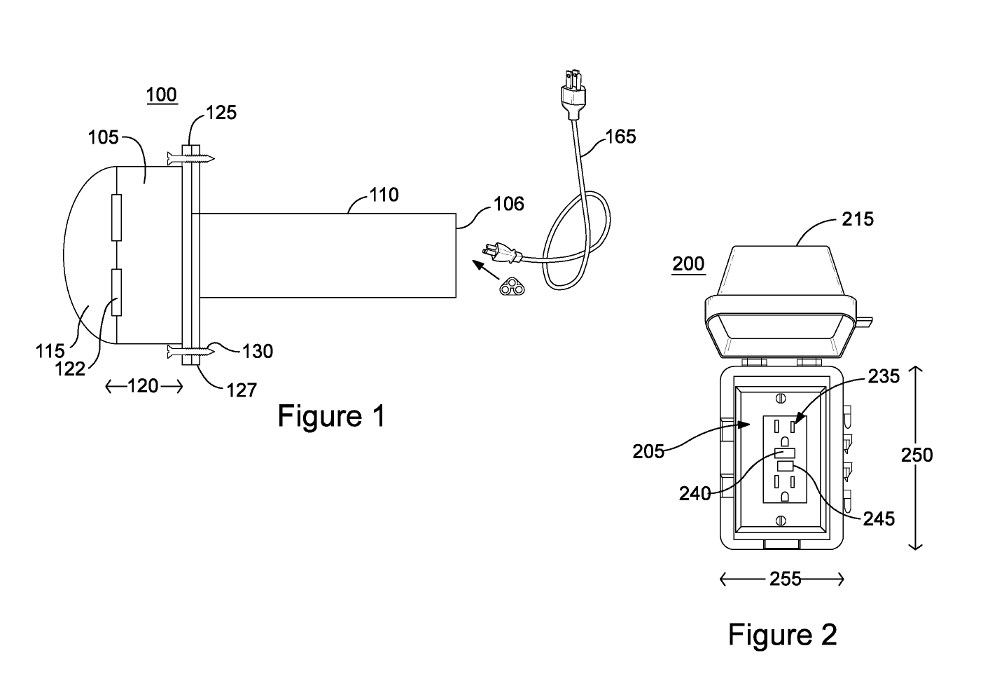

FIG. 1 illustrates a side view of an exemplary electrical extension apparatus 100 according to an embodiment of the present invention. The electrical extension apparatus includes a first portion of a socket 105 and a conduit 110. Suitable first portions of the socket include, but are not limited to a GFCI socket, a NEMA 1-15 socket, a JIS C 8303 Class I socket, a NEMA 5-15 socket, a NEMA 5-20 socket, a JIS C 8303 Class II socket, a CEE 7/16 socket, a CEE 7/17 socket, a GOST 7396 C 1 socket, a BS 546 socket, a CEE 7/5 socket, a CEE 7/4 socket, a BS 1363 socket, an IS 401 socket, an IS 411 socket, a MS 589 socket, a SS 145 socket, a SI 32 socket, a TIS 166-2549 socket, an AS/NZS 3112 socket, a CPCS-CCC socket, an IRAM 2073 socket, a SEV 1011 socket, a 107-2-D1 socket, a CEI 23-16/VII socket, an IEC 60906-1 socket, a BS 4573 socket, a Multi Standard Socket A, and a Multi Standard Socket B. The first portion of a socket may include a seal to prevent moisture and contaminants from entering the conduit.

In some embodiments, the first portion of a socket may be disposed in a casing 115. The casing may have a thickness 120. The thickness 120 may be in the range of 1/16″ to ¾″. Suitable materials for the casing include, but are not limited to, a polymer, plastic, rubber, metal, ABS plastic, PVC, fiberglass, polypropylene, CPVC, or combinations thereof. In one embodiment, the casing 115 may be a sliding door. In another embodiment, the casing 115 may snap on and off of the first portion of the socket 105. In some embodiments, the casing 115 may include a hinge 122. The casing 115 may pivot along an axis associated with the hinge 122. In some embodiments, the casing may be waterproof. The outer perimeter of the casing may include a seal to restrict moisture and contaminants from entering the first portion of a socket.

The first portion of the socket 105 may be secured to a plate 125 with a fastening mechanism 130. Suitable materials for the plate 125 include, but are not limited to, plastic, metal, steel, aluminum, or a combination thereof. In some embodiments, the plate may be removably joined to a wall. Suitable fastening mechanisms include, but are not limited to, a screw, a nail, a bolt, adhesive glue and a combination thereof. In some embodiments, the fastening mechanism 130 secures the first portion of the socket 105 to the conduit 110. In other embodiments, the fastening mechanism 130, secures the plate 125 to the conduit 110. In some embodiments, the fastening mechanism 130, secures each of the first portion of the socket 105, the plate 125, the conduit 110, and a wall. In some embodiments, the first portion of the socket 105 is located outside of a building. In some embodiments, an insulating material 127 is provided. Suitable insulating materials include, but are not limited to, rubber, plastic, a polymer, foam rubber and combinations thereof. The insulating material may be a gasket. In one embodiment, the plate rests flush against the wall.

FIG. 2 illustrates a front view of an exemplary electrical extension apparatus according to an embodiment of the present invention. The first portion of the socket 205 may include at least one receptacle 235. The receptacle may include, but not be limited to CEE 7/4 and CEE 7/5. In some embodiments, the first portion of the socket 205, includes at least one of a reset toggle switch 240 and a test toggle switch 245. In some embodiments, the first portion of the socket 205 may include a height 250. The height 250 may be in the range of 4″ to 7″. In some embodiments, the first portion of the socket 205 may include a width 255. The width 255 may be in the range of 2″ to 5½″. In some embodiments, the first portion of the socket 205 may be disposed in a casing 215.

Those skilled in the art, in light of the present teachings, will appreciate that safety measures may require sockets to be designed to accept only compatible plugs in the correct orientation, and otherwise reject all others. Some sockets may include, without limitation, shutters to block insertion of objects other than compatible plugs. In some alternative embodiments, the sockets may be designed to prevent exposure of bare live contacts. In some alternative embodiments, the exposed contacts present in some sockets may be used exclusively for grounding.

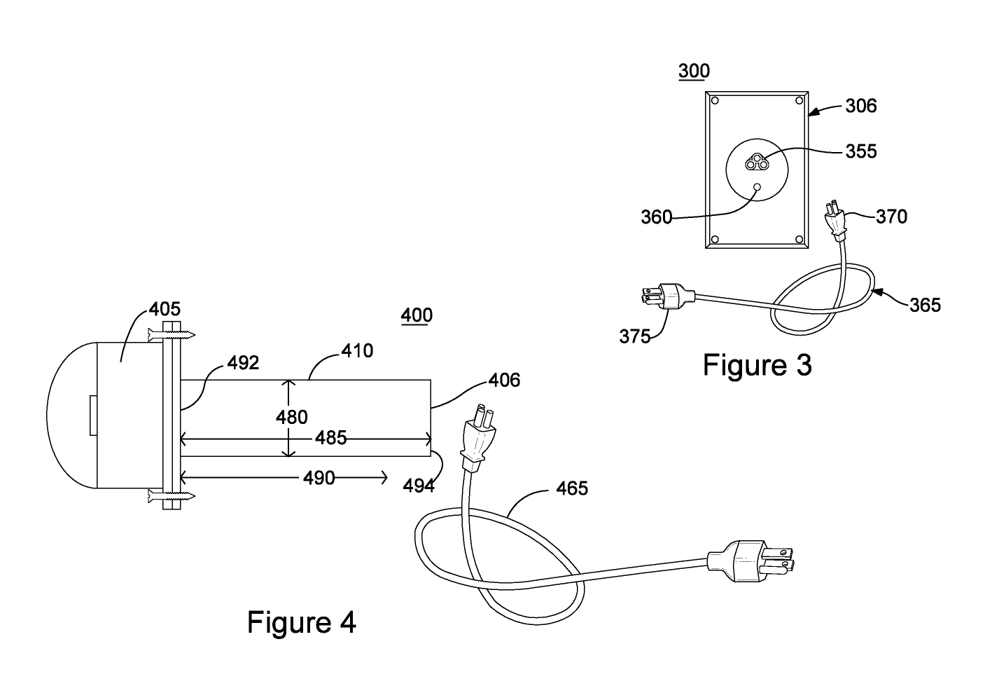

FIG. 3 illustrates a back view of an exemplary electrical extension apparatus according to an embodiment of the present invention. A second portion of a socket 306 may include at least one outlet 355. In some embodiments the outlet is connected to the receptacle 235. Suitable outlets include, but are not limited to, a three prong outlet and a ground fault circuit interrupted receptacle. In some embodiments, the second portion of the socket 306 may include an indicator 360. In one embodiment, the indicator 360 reveals if power is provided to the outlet 355. Suitable indicators include, but are not limited to, a light, a light emitting diode, an audible indicator, or a combination thereof.

In some embodiments, a cable 365 may be joined to the outlet 355. The cable 365 may include a first end 370 and a second end 375. The first end 370 may be configured to interconnect with the outlet 355. In some embodiments, the first end 370 is removably joined to the outlet 355. The second end may be configured to interconnect with a receptacle. In some embodiments, the second end 375 is removably joined to the receptacle. Suitable receptacles include, but are not limited to a GFCI receptacle, a NEMA 1-15 receptacle, a JIS C 8303 Class I receptacle, a NEMA 5-15 receptacle, a NEMA 5-20 receptacle, a JIS C 8303 Class II receptacle, a CEE 7/16 receptacle, a CEE 7/17 receptacle, a GOST 7396 C 1 receptacle, a BS 546 receptacle, a CEE 7/5 receptacle, a CEE 7/4 receptacle, a BS 1363 receptacle, an IS 401 receptacle, an IS 411 receptacle, a MS 589 receptacle, a SS 145 receptacle, a SI 32 receptacle, a TIS 166-2549 receptacle, an AS/NZS 3112 receptacle, a CPCS-CCC receptacle, an IRAM 2073 receptacle, a SEV 1011 receptacle, a 107-2-D1 receptacle, a CEI 23-16/VII receptacle, an IEC 60906-1 receptacle, a BS 4573 receptacle, a Multi Standard Socket receptacle A, and a Multi Standard Socket receptacle B. In some embodiments, the second end 375 is configured to interconnect with a receptacle located inside of a building. In some embodiments, the second portion of the socket 306 is located inside of a building.

FIG. 4 illustrates a bottom view of an exemplary electrical extension apparatus according to an embodiment of the present invention. The electrical extension apparatus 400, may include a conduit 410. Suitable materials for the conduit include, but are not limited to a light tubing, metal, polymer, plastic, rubber, fiber, fired clay or combinations thereof. The conduit may include a first dimension 480. The first dimension 480 may be in the range ¾″ to 4″. The conduit may also include a second dimension 485. The second dimension 485 may be in the range of 1.5″ to 16″. In some embodiments, conduit 410 may include an extension mechanism. Suitable extension mechanisms include, but are not limited to, a slidable insert, a system of interlocking threads, and a combination. In some embodiments, the extension mechanism increases or decreases the second dimension 485 to a length 490. The length 490 may be in the range of 1″ to 16″. In one embodiment, the conduit is sufficiently rugged to protect interior wiring from, but not limited to, studs, insulation, piping, and wires that may be found within walls. The conduit may also be sufficiently flexible to avoid obstacles within walls.

In one alternative embodiment, the conduit may also include multiple arms for including multiple socket portions. In this manner, the conduit may provide numerous outdoor sockets from a single indoor socket. In yet another embodiment, the conduit may transfer both A/C and D/C current.

In some embodiments, the conduit includes a first end 492 and a second end 494. The first end 492 may be joined to the first portion of the socket 405. The second end 494 may be joined to the second portion of the socket 406. In some embodiments, the first end 492 is located outside of a building. In some embodiments, the second end 494 is located inside of a building. The conduit 410 may contain wiring connecting the first portion of the socket 405 to the second portion of the socket 406. In some embodiments, the conduit includes a system for wireless energy transfer. In some embodiments, the conduit 410 may include an inner material and an outer material. Suitable inner materials include, but are not limited to a polymer, plastic, rubber, metal, or combinations thereof. Suitable outer materials include, but are not limited to a polymer, plastic, rubber, metal, or combinations thereof. In some embodiments, the conduit 410 includes a bendable elbow. In other embodiments, the conduit 410 is bendable at any point. In some embodiments, the conduit 410, extends through a wall. In another alternative embodiment, the power transfers multi-directionally. By way of example, and not limitation, if there is a dearth of sockets inside the building, an outdoor power source may transmit power from the first portion of a socket to the second portion of a socket.

In one alternative embodiment, the conduit fabrication, installation, and utilization may comply with the National Electrical Code (NEC). The conduit may include wiring that is sheathed at least 0.020″ and resists temperatures up to 220 degrees Fahrenheit. In another embodiment, the definitions and rules for installations (voltages, connections, markings, etc.), circuits and circuit protection, methods and materials for wiring (wiring devices, conductors, cables, etc.), and general-purpose equipment (cords, receptacles, switches, heaters, etc.) recommended by the NEC may be utilized.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing an electrical extension apparatus according to the present invention will be apparent to those skilled in the art. The invention has been described above by way of illustration, and the specific embodiments disclosed are not intended to limit the invention to the particular forms disclosed. The particular implementation of the electrical extension apparatus may vary depending upon the particular context or application. By way of example, and not limitation, the electrical extension apparatus described in the foregoing were principally directed to electrical power implementations; however, similar techniques may instead be applied to network signals, including, but not limited to a wireless network, which implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An electrical extension apparatus comprising:
a first portion of a socket, said first socket portion comprising at least one receptacle;
a second portion of a socket, said second socket portion comprising at least one outlet;
a conduit, said conduit being configured to transmit power from said first portion of a socket to said second portion of a socket, said conduit comprising a first end, said conduit further comprising a second end; and
a cable, said cable being operable to provide power to said first portion of a socket when joined with said second portion of a socket.

2. The electrical extension apparatus of claim 1, wherein said conduit comprises at least one wire for transferring power.

3. The electrical extension apparatus of claim 1, wherein said conduit is flexible and extendable.

4. The electrical extension apparatus of claim 1, wherein said conduit is configured to penetrate a wall.

5. The electrical extension apparatus of claim 1, in which said conduit comprises of a first dimension, said conduit further comprises of a second dimension, said second dimension further comprises of a length.

6. The electrical extension apparatus of claim 1, wherein said first portion of a socket is positioned outside of a building.

7. The electrical extension apparatus of claim 1, in which said first portion of a socket comprises of a plate, and said plate comprises of a fastening mechanism, and said fastening mechanism is operable to secure said plate against said first portion of a socket.

8. The electrical extension apparatus of claim 1, in which said plate comprises a seal to provide a waterproof seal around the perimeter of said first portion of a socket.

9. The electrical extension apparatus of claim 1, in which said first portion of a socket comprises of at least one reset toggle switch, and said first portion of a socket further comprises of at least one test toggle switch.

10. The electrical extension apparatus of claim 1, in which said first portion of a socket comprises of a casing, said casing is configured to cover said first portion of a socket, said casing is rotatably secured to said first portion of a socket for selectively closing or opening, said casing comprises of a thickness.

11. The electrical extension apparatus of claim 1, in which said first portion of a socket comprises a height, and said first portion of a socket further comprises of a width.

12. The electrical extension apparatus of claim 1, wherein said second portion of a socket is positioned inside of a building.

13. The electrical extension apparatus of claim 1, in which said second portion of a socket comprises of an indicator, wherein said indicator is operable to indicate the presence of power.

14. The electrical extension apparatus of claim 1, in which said cable comprises of a first end, and said cable further comprises of a second end.

15. The electrical extension apparatus of claim 1, wherein said first end is configured to removably join said receptacle.

16. The electrical extension apparatus of claim 1, wherein said second end is configured to removably join said outlet.

17. The electrical extension apparatus of claim 1, wherein said conduit transfers power wirelessly.

18. The electrical extension apparatus of claim 1, wherein said conduit transfers power multi-directionally.

19. An electrical extension apparatus comprising:
means for passing a conduit through a wall;
means for joining a first end of cable to an outlet for a second portion of a socket;
means for joining a second end of said cable to a power source;
means for joining a second end of a cable to a receptacle for a first portion of a socket; and
means for providing power to said first portion of a socket.

20. An electrical extension apparatus comprising:
a first portion of a socket, said first socket portion comprising a plate, said plate comprising a fastening mechanism, said fastening mechanism being operable to secure said plate against said first portion of a socket against, said first socket portion further comprising at least one receptacle, said first socket portion further comprising further comprising a casing, said casing being configured to cover said socket, said casing comprising a thickness, said casing further comprising a hinge, said hinge being operable to pivotally rotate said casing, said first portion of a socket further comprising at least one reset toggle switch, said first portion of a socket further comprising at least one test toggle switch, said first portion of a socket further comprising a height, said first portion of a socket further comprising a width;
a second portion of a socket, said second socket portion comprising at least one outlet, said second socket portion further comprising an indicator, said indicator being operable to indicate the presence of power;
a conduit, said conduit being configured to transmit power from said first portion of a socket to said second socket portion, said conduit comprising a first end, said conduit further comprising a second end, said conduit further comprising a first dimension, said conduit further comprising a second dimension, said second dimension further comprising a length; and
a cable, said cable being operable to provide power to said first portion of a socket when joined with said second socket portion, said cable being configured to removably join with said at least one receptacle, said cable being further configured to removably join with said at least one outlet, said cable comprising a first end, said cable further comprising a second end.
